(19) United States
(12) Patent Application Publication
(10) Pub. No.: US 2023/0035102 A1
(43) Pub. Date: Feb. 2, 2023

(54) FULTON 54 SCORING SYSTEM FOR GOLF

(71) Applicant: DARRELL V.A. FULTON, SR., ALTADENA, CA (US)

(72) Inventor: DARRELL V.A. FULTON, SR., ALTADENA, CA (US)

(21) Appl. No.: 17/877,632

(22) Filed: Jul. 29, 2022

Related U.S. Application Data
(60) Provisional application No. 63/228,346, filed on Aug. 2, 2021.

(51) Int. Cl. A63B 71/06

(52) U.S. Cl. CPC A63B 71/0669

(57) ABSTRACT

Described is a system for scoring a golf game based on individual plays. The system scores a golf game based on an ideal/perfect/maximum score and establishes the “perfect score” as 54 points based on a 3 point maximum number of points per hole over 18 holes. On approach to a par-4 or par-5 hole, the system rewards a player with one point if the player succeeds in hitting the fairway from the tee. A player receives 1 point for hitting the green in regulation. If the player is targeting a par-3 hole, the system rewards the player with 2 points if the player's first shot from the tee lands on the green. At any hole, another point is awarded to a player if the player, while on the green, successfully executes a 1-putt. A player who successfully executes these plays for 18 holes achieves the maximum score of 54 points.

### CROSS-REFERENCE TO RELATED APPLICATIONS

This is a non-provisional application of U.S. provisional application No. 63/228,346, filed Aug. 2, 2021, the entirety of which is incorporated herein by reference.

### BACKGROUND OF INVENTION

### (1) Field of the Invention

The present invention relates generally to tracking performance in a golf game, and more particularly, a scoring system for a golf game.

### (2) Description of Related Art

Golf, like many other sports, has been transformed by the evolution of sports equipment. The modern golf club bears little resemblance to the classic golf clubs in terms of the power that an individual is able to produce when striking a golf ball. As a result, a golf ball can be driven to locations substantially beyond which the classic club would have required multiple strikes to attain.

Golf was created to be a game of precision. However, as the technology of the golf club evolved, the importance of power has substantially increased at the expense of precision and ball striking accuracy in the modern golf game. In fact, the power game has been responsible for an increase in average size/dimensions of the modern golf course. In some cases, older and shorter golf courses are considered obsolete.

Similar to golf, a number of other sports/games including baseball and bowling were designed to be games of precision. Bowling and baseball are played based on respective perfect scoring standards. The scoring standard represents an ideal game performance. For example, bowling uses the standard called the “300”, while baseball has the “no-hitter”. Golf, on the other hand, has no standard perfect/ideal scoring system.

Many of the stakeholders in the golf game are increasingly concerned with the state of the golf game especially as older courses are considered outdated and the importance of precision and accuracy to a player's performance continues to diminish.

### SUMMARY OF INVENTION

The present invention is directed to a method, a system and a computer program product that provide scoring for a golf game based on individual plays/shots. A Fulton Standard Scoring (FSS) utility scores a golf game based on an ideal/perfect/maximum score. In an implementation, the FSS utility establishes the ideal/maximum score as fifty-four (54) points based on a 3 point maximum number of points per hole over 18 holes. On a player's approach to a par-4 or par-5 hole, the FSS utility rewards a player with one point if the player succeeds in having the golf ball come to rest on the fairway after the ball is hit from the tee. Additionally, a player receives 1 point for hitting the green in regulations or less. If the player is targeting a par3 hole, the FSS utility rewards the player with two (2) points if the player's first shot from the tee lands on the green. At any hole, another point is awarded to a player if the player, while on the green, successfully executes a 1-putt. A player who successfully executes these plays for eighteen (18) holes achieves the target/maximum score of 54 points. The FSS utility tracks each player's scoring performing round by round and provides updated scores and player rankings via a scoreboard.

According to an aspect, one or more computer readable images/objects/codes that can be used to activate the golf game are presented to individuals via a software application. The FSS module configures the golf game in response to receiving indications based on a number of individuals interacting with the computer readable objects.

According to another aspect, a golf simulator is utilized. The FSS utility analyzes the golf shot using recorded golf shot information provided by the simulator and/or a shot analyzer. According to one or more aspects, the simulator tracks a golf ball that is struck by a golfer and determines a projected track of the golf ball relative to a virtual fairway, virtual putting green and/or virtual target hole.

According to an aspect, the FSS utility/simulator is able to determine the projected track for the golf ball that is struck from an off-course (i.e., virtual golf course) location, such as at the golfer's/individual's home (i.e., separate/different from a real golf course).

According to an aspect, the FSS utility determines based on the recorded and/or simulated golf shot whether the golfer should be awarded a specified number of points (e.g., 1 point or 2 points) for the current shot. According to an aspect, the FSS utility utilizes the shot analyzer to determine whether the shot satisfies any criterion/condition that enables the golfer/individual to be awarded the specified number of points. The shot analyzer is able to determine any of the following (i) whether the player succeeds in hitting the fairway or the green from the tee; (ii) whether the player hits the green in regulation; and (iii) whether the player successfully executes a 1-putt, while on the green.

According to an aspect, the FSS utility can configure a golf game for one of two game formats, including a professional format and an amateur format.

According to one or more aspects, the FSS module applies a tie-breaker if the final scores indicate that multiple players are tied with the same highest score. In a first configuration, such as in the Pro Format, a tiebreaker can be broken by awarding points in order for achievements including. (i) number of Albatrosses; (ii) number of Holes-In-One; (iii) number of Eagles; (iv) number of Birdies; and (v) number of Pars. The FSS utility 108 assesses updated scores after one or more points are awarded for a respective achievement based on listed order to determine whether the tie is broken and a single winner emerges.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 illustrates a block diagram representation of an example data processing system within which certain features of the present disclosure can be implemented, according to one or more embodiments;

FIG. 2 illustrates a computer network for enabling individuals in various locations to score a real or simulated golf game using the perfect scoring system, according to one or more embodiments of the disclosure;

FIG. 3 presents an illustration of an example game playing and golf shot recording environment, according to one or more embodiments,

FIG. 4 presents a flow chart illustrating the process of scoring a golf game using the perfect scoring system, according to one or more embodiments; and

FIG. 5 presents a flow chart illustrating the process of using a recording of a golf shot to determine whether points should be awarded to a golfer, according to one or more embodiments.

Like reference numerals refer to like parts throughout the several views of the drawings.

### DETAILED DESCRIPTION

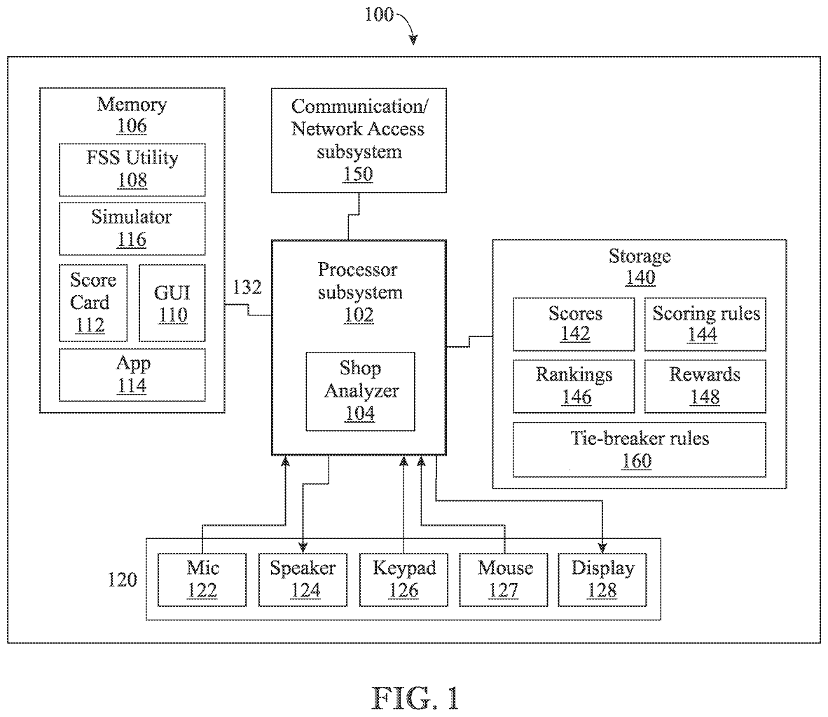

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”. “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present disclosure is directed toward a scoring for a golf game based on individual shots and an optimized scoring system.

With reference now to the figures, and beginning with FIG. 1, there is depicted a block diagram representation of an example data processing system (DPS), as utilized within one embodiment. DPS may be a server, a digital audio workstation, a personal computer, a portable device, such as a personal digital assistant (PDA), a smart phone, and/or other types of electronic devices that may generally be considered processing devices or computing systems/devices. As illustrated, DPS 100 comprises at least one processor subsystem 102 connected to system memory 106 via system interlink/bus 132 DPS 100 executes one or more computer programs/applications to activate and configure a golf game to be played in one of a professional format and an amateur format using a golf game simulator and/or recording device and/or sensors to record and track golf shots made by the golfer/player, according to the present disclosure.

In one or more embodiments, data processing device 100, which is managed by processor subsystem 102, also includes communication subsystem 150, data storage subsystem 140, and input/output (I/O) subsystem 120. As shown, processor subsystem 102 includes a shot analyzer module 104 to support the data analysis functionality of DPS 100. Processor subsystem 102 executes program code to provide operating functionality of data processing device 100. The software and/or firmware modules have varying functionality when their corresponding program code is executed by processor subsystem 102 or secondary processing devices (not explicitly shown) within DPS 100.

As illustrated, I/O subsystem 120 includes user interface devices including output devices such as audio output device(s)/speaker 124, and display device 128. In one or more implementations, display device 128 includes touch screen functionality enabling display device to function as both an input device and an output device. In addition, I/O subsystem 120 includes input devices including microphone 122, keypad 126 and mouse 127.

Processor subsystem 102 is communicatively coupled, via system bus/interlink 132, to device memory 106. In one or more embodiments, processor subsystem 102 is communicatively coupled via system interlink 132 to communication subsystem 150, data storage subsystem 140, and input/output subsystem 120. System interlink 132 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components.

Communication subsystem 150 may be configured to enable DPS 100 to communicate with a plurality of personal computing devices. The communication subsystem may include wired and/or wireless communication devices to facilitate networked communication. Communication subsystem 150 also includes a Network Access Module by which DPS 100 may connect to one or more access/external networks such as the Internet or wide area network (WAN), or an internal network such as an Ethernet (local area network-LAN) or a Virtual Private Network (VPN).

In addition to the above described hardware components of DI'S 100, various features of the invention are completed/supported via software (or firmware) code or logic stored within memory 106 or other storage and executed by Processor subsystem 102. Thus, for example, illustrated within memory 106 are a number of software/firmware/logic components, including Application 114 and other applications (not shown). In addition, memory 106 comprises a Fulton Standard Scoring (FSS) module/logic/utility 108. Device memory 106 further includes an operating system (OS) (not shown), a firmware interface, such as basic input-output system (BIOS) or Uniform Extensible Firmware Interface (UEFI), and firmware (not shown). Device memory 106 includes a graphical user interface (GUI) 110, a scoring card 112, a Simulator 116, and/or other computer data (not explicitly shown) used by the FSS utility 108 and/or the Simulator 116.

Data storage subsystem 140 enables further storage and retrieval of data, instructions, and code. In particular, data storage subsystem 140 provides applications, program code, and stored data on nonvolatile storage that is accessible by processor subsystem 102. For example, data storage subsystem 140 can provide, for use by the FSS utility 108, the player scores 142, scoring rules 144, players' rankings 146, rewards 148, and tie-breaker rules 160. In addition, data storage subsystem 140 can provide a selection of program code and applications such as Simulator 116, and other related application(s) that can be used to configure and activate golf games in respective formats. These applications can be loaded into device memory 106 for execution by processor subsystem 102.

In actual implementation, the FSS logic 108 may be combined with the Simulator 116 to provide a single executable component, collectively providing the various functions of each individual component when the corresponding combined component is activated. For simplicity, the FSS logic/utility 108 is illustrated and described as a stand-alone or separate logic/firmware component, which provides specific functions, as described below.

In one embodiment, DPS 100 communicates with a software deploying server (not shown) via a network (e.g., the Internet) using communication subsystem/network access module 150. Then, FSS utility 108 may be deployed from/on the network, via the software deploying server. With this configuration, the software deploying server performs all of the functions associated with the execution of FSS utility 108. Accordingly, DPS 100 is not required to utilize internal computing resources of DPS 100 to execute FSS utility 108.

The FSS utility 108 provides a golf shot precision based scoring standard that is based on a maximum/perfect score. The individual/player can be presented with audio, visual and/or textual content associated with various game conditions and statuses via an output device of the I/O subsystem. According to an aspect of the present disclosure, the FSS utility/module 108 enables the individual to provide responses/feedback to the presented content via the GUI 110. According to one or more aspects, the individual/participant/player can be presented with aural content via the speakers 124. The participant may also be visually presented via the display device 128 with image, video and/or textual content. In addition, the participant may be visually presented with one or more associated selection buttons, including game format selection buttons, within the GUI 110. Using an input device, such as the mouse 127, the keypad 126 or the microphone 127, the participant can provide an input selection as a response to presented content.

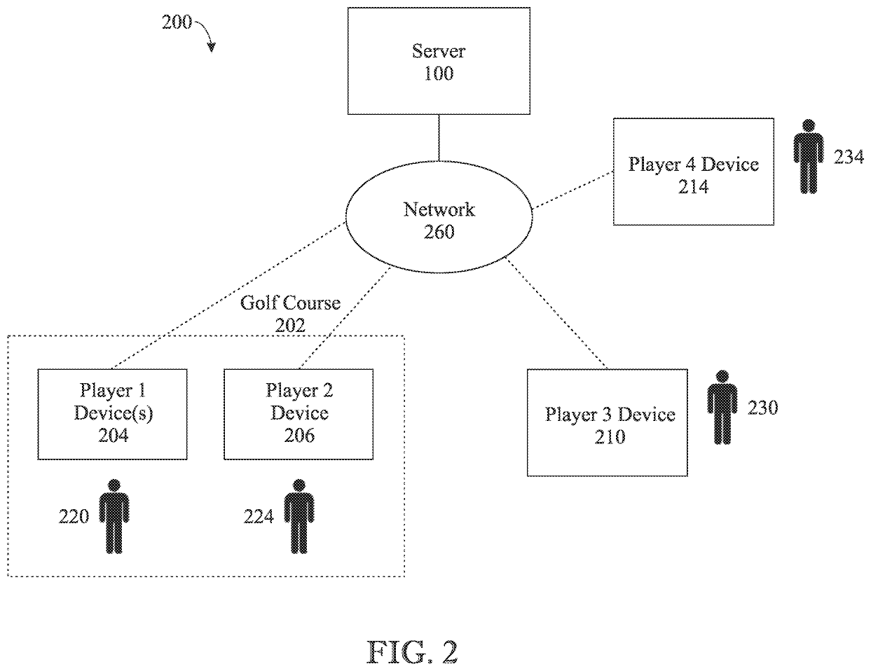

Certain of the functions supported and/or provided by the FSS utility/module 108 are implemented as processing logic (or code) executed by processor subsystem 102 and/or other device hardware, which processing logic enables the device to implement/perform those function(s). Among the software code/instructions/logic provided by the FSS module 108, and which are specific to the disclosure, are: (a) logic for establishing a “perfect score” based on a maximum number of points per hole over 18 holes; (b) logic for rewarding a player with one point if the player succeeds in hitting the fairway on a par-4 or par-S approach from the tee; (c) logic for rewarding a player with two (2) points if the player succeeds in hitting the green on a par-3 approach from the tee (c) logic for rewarding the player with 1 point for hitting the green in regulation on a par-4 or par-5 approach; (d) logic for rewarding the player with 1 point if the player, while on the green, successfully executes a 1-putt; (e) logic for updating the player's score tally as points are added to the player's score; (f) logic for providing players' scores and rankings based on the perfect scoring system throughout the game via a scoreboard; (g) logic for identifying a winner as the player with the highest score; and (h) logic for receiving a recording of a golf shot via a simulator and/or recording equipment/sensors. According to the illustrative embodiment, when Processor subsystem 102 executes the FSS logic/module 108, DPS 100 initiates a series of functional processes that enable the above functional features as well as additional features/functionality. These features/functionalities are described in greater detail below within the description of FIGS. 2-5.

Those of ordinary skill in the art will appreciate that the hardware components and basic configuration depicted in FIG. 1 may vary. The illustrative components within DPS 100 are not intended to be exhaustive, but rather are representative to highlight essential components that are utilized to implement the present disclosure. For example, other devices % components may be used in addition to or in place of the hardware depicted. The depicted example is not meant to imply architectural or other limitations with respect to the presently described embodiments and/or the general disclosure.

Referring now to FIG. 2, a computer network 200 for enabling individuals at various locations to score a real or simulated golf game using the perfect scoring system, according to one or more embodiments of the disclosure. As illustrated in the computer network 200, a number of computing % electronic devices are included. These computing devices, which can be similarly configured to DPS 100 (FIG. 1), include a server 100, a first player's device(s) 204, player-2 device 206, player-3 device 210 and player-4 device 214. The various computing devices are connected by a network 260. The network 260 can be any of the various networks, including a LAN or a WAN/Internet, described in FIG. 1.

The computer network 200 allows scores/scoring cards, award notification and other game status/scores information to be sent by the server to the various players at the respective devices. In addition, response from the various players can be received by the server 100. Based on the communicated/received information, the FSS utility/module 108 can download configuration and control information to the various player devices, respectively.

According to one or more aspects, and as illustrated in FIG. 2, player-1 220 and player-2 224 with their respective devices are shown within a golf course environment 202. According to an aspect, player-3 230 and player-4 234 are located in separate remote locations. According to one or more aspects, the player devices 204 include a personal laptop/tablet computer and a smart-phone.

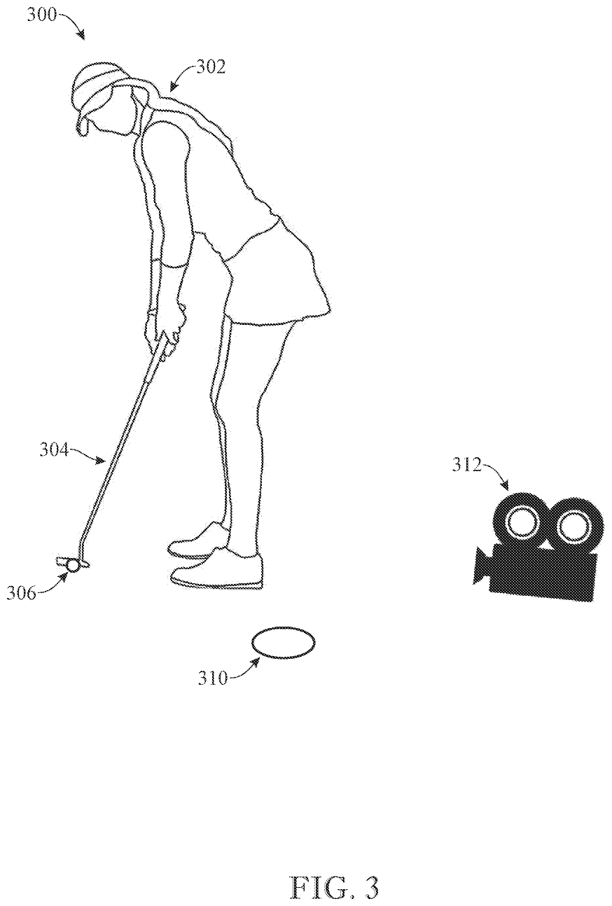

FIG. 3 presents an illustration of an example game playing and golf shot recording environment, according to one or more embodiments. Environment 300 includes a golfer/player 302 holding a golf club 304 as she prepares to hit/putt a golf ball 306 on the putting green. In addition, the environment 300 includes a hole 310. Also illustrated in the environment 300 is recording equipment 312. According to another aspect, a cell phone camera is utilized to record a player's golf shots. According to one or more aspects, the environment 300 is a real golf course location at which a golfer has his/her golf strokes recorded to be sent for shot analysis via a shot analyzer 104.

According to another aspect, a golf simulator 116 is utilized. The FSS utility 108 analyzes the golf shot using golf shot information provided by the simulator 116 and/or the shot analyzer 104. According to one or more aspects, the simulator 116 tracks a golf ball that is struck by a golfer and determines a projected track of the golf ball relative to a virtual fairway, virtual putting green and/or virtual target hole. According to an aspect, the FSS utility 108 is able to determine the projected track for the golf ball that is struck from an off course location (i.e., a virtual golf course), such as at the golfer's/individual's home (i.e., separate/different from a real golf course).

According to one or more aspects, the FSS utility 108 determines based on the recorded and/or simulated golf shot whether the golfer should be awarded a specified number of points for the current shot. According to an aspect, the FSS utility 108 utilizes shot analyzer 104 to determine whether the shot satisfies any criterion/condition that enables the golfer/individual to be awarded a specified number of points. The shot analyzer 104 is able to determine any of the following (i) whether the player succeeds in hitting the fairway from the tee; (ii) whether the player hits the green in regulation; and (iii) whether the player successfully executes a 1-putt, while on the seen. If the FSS utility 108 determines that the shot satisfies a specified condition, the FSS utility 108 awards the specified number of points to the player/golfer.

According to one or more aspects, the simulator 116 is a fairway, regulation and putt (FRP) simulator that analyzes and projects golf shots relative to a number of locations including the fairway or putting green. Additionally, the FRP simulator 116 determines whether the green is hit within regulation. The recorded golf shot provides objective proof either in the Simulator or on the Driving Range of the player's shot and/or shot result.

According to an aspect, the FSS module 108 allows the player to roll a ball that is located in a divot on the fairway out of the divot to a position that places the golf ball no closer to the hole. According to a related aspect, the FSS module 108 allows the player to exercise an option to have the player's opponent PUTT first or apply a veto. According to established rules, a player may be provided with one opportunity to putt first for every nine (9) holes even if spread between the front and back nine. Similarly, based on the established rules, a player may be provided with one opportunity to veto for every eighteen (18) holes. According to another aspect, the FSS module 108 allows the opponent to use his % her option, if the option is still available/unused, to override or veto the player's exercising his/her option to have the opponent putt first. If the veto/override is applied, the FSS module 108 executes the default vile which specifies that the player whose golf ball is farthest from the hole will putt first.

According to one or more aspects, the FSS utility 108 can configure a golf game for one of two game formats. A first game format is THE PRO (FRP FORMAT). A second game format is the AMATEUR (STEG-Same Tee Equity Golf) Format. According to an aspect, the FSS utility 108 can award a player with a precision scoring credit if on par-4 and par-S hole approaches, all of the player's shots from the Tee, prior to hitting the golf ball on the Green, stays on the fairway (i.e., maintains a Fairway status). The FSS utility 108 enables the precision scoring credit to be applied to a player's score in a game in which a player's score is established using a regular scoring standard. As provided within the regular scoring standard, a lowest score on a hole wins the hole. Thus, the FSS utility 108 applies the precision scoring credit to enhance the player's score by reducing the player's actual stroke count by one. In response to the FSS utility 108 applying the precision scoring credit to a player's score, a bogey (score) is boosted/improved to or becomes a Par (score), a Par becomes a Birdie, and a Birdie becomes an Eagle, etc.

According to one or more aspects, the FSS utility 108 enables a ranking system to be established based on the golfer's scoring history and statistical record. According to an implementation, the FSS utility 108 tracks the player's game statistics associated with perfect scoring standard specifications, based on fairways hit, greens in regulation, one putts while on the green, etc. Using the tracked game statistics, the FSS utility 108 establishes a player's world standing/ranking by dividing a first score established using the regular scoring standard by a second score determined using the perfect scoring standard. According to an aspect, the FSS utility 108 uses scores, such as the first and second scores, based on a tally for a round or some other specified segment of golf play to establish the world standard. According to a related aspect, the FSS utility 108 uses scores, such as the first and second scores, that are attained during a specified period of time (e.g., a few weeks, a few months, or a year) within a golf playing season to determine the world standard/ranking. According to a related aspect, the FSS utility 108 can be configured to support various leagues for different levels of player skill and/or ability within a world standard/ranking system. According to an aspect, the FSS utility 108 identifies the player with the lowest numerical value for the calculated world standard/ranking as the player with the highest/best standing/rank in the world.

According to one or more aspects, the FSS module 108 applies a tie-breaker if the final scores indicate that multiple players are tied with the same highest score. In a first configuration, such as in the FRP Format, a tiebreaker can be broken by awarding points in order for achievements including: (i) number of Albatrosses; (ii) number of Holes-In-One; (iii) number of Eagles; (iv) number of Birdies; and (v) number of Pars. The FSS utility 108 assesses updated scores after one or more points are awarded for a respective achievement based on listed order to determine whether the tie is broken and a single winner emerges.

In a second configuration, such as in the STEG Format, a tiebreaker can be broken by awarding points in order for achievements including: (i) number of fairways hit; (ii) number of Greens in Regulation (GIRs); (iii) number of putts; (iv) number of Albatrosses; (v) number of Holes-In-One; (vi) number of Eagles; (vii) number of Birdies; and (viii) number of Pars. The FSS utility 108 assesses updated scores after one or more points are awarded for a respective achievement based on listed order to determine whether the tie is broken and a single winner emerges.

According to an established set of rules of golf, the FSS module 108 enables a player to obtain relief from an obstruction or adverse playing condition by using a golf club to perform a measurement before dropping the ball to initiate a ball strike. Unlike the traditional golf game in which a player may obtain relief from anywhere by using any club to measure before dropping the golf ball before striking it, the FSS module 108 enables the player to obtain relief by restricting the player to using the same club to perform the measurement that the player will use to play the shot.

According to an aspect, the golf game using the perfect scoring system can be played in any of two modes. The first/default mode is the previously described approach which involves the accumulation of points up to a maximum of 54 points. A second mode involves the protecting of points in which the player is initially awarded points for a hole at the start of play for each respective hole. Points are subtracted if the player misses a target but are maintained if the player does not miss a target. For example, the FSS module 108 maintains the points awarded prior to play on the hole if the player does not miss: (i) the Fairway/Green on first shot; (ii) the Green in Regulation; and/or (iii) the hole in one shot while on the Green.

According to an aspect, the FSS module 108 allows the player to select which mode in which to configure the game to be played. According to another aspect, the FSS module 108 allows a player to play both the first and second modes simultaneously in a 18-hole competition format or in an alternate format using a selected set of holes. According to one or more related aspects, the FSS module 108 presents the scores corresponding to each of the two modes in respective areas of a display.

According to an aspect, the FSS utility 108 and the perfect scoring system supports the use of a simplified scoring card. The scoring card identifies the player by name and clearly delineated spaces to record points obtained for shots relative to and/or based on Fairway-Regulation & Putts.

According to one or more aspects, the FSS utility 108 utilizes the perfect scoring system instead of a handicap system as a means to level the playing field.

According to an aspect, the FSS module 108 enables individuals to subscribe as playing and non-playing members in a membership program. The FSS module 108 enables individuals/players to earn reward points for every Fairway/Regulation/Putt “FRP” scored while playing a game within which the perfect scoring system/standard corresponding to the FSS utility is incorporated/integrated. For example, points can be earned while playing or participating in one or more of: (i) video games; (ii) golf simulation; (iii) driving range; and (iv) golfing.

The FSS module/utility 108 enables rewards points to be used towards the acquisition of products and services available through partnerships with various vendors associated with a wide range of industries including travel, entertainment, and shopping. In addition, these partnerships can provide access to a range of big ticket items such as a Superbowl Experience, College Scholarships and Automobiles.

According to an aspect, the FSS module 108 enables members to associate non-profit organizations with their member subscriptions. According to one or more related aspects, the FSS module 108 enables financial donations to be made to a non-profit organization associated with an individual's membership based on the member's participation and/or the reward points earned.

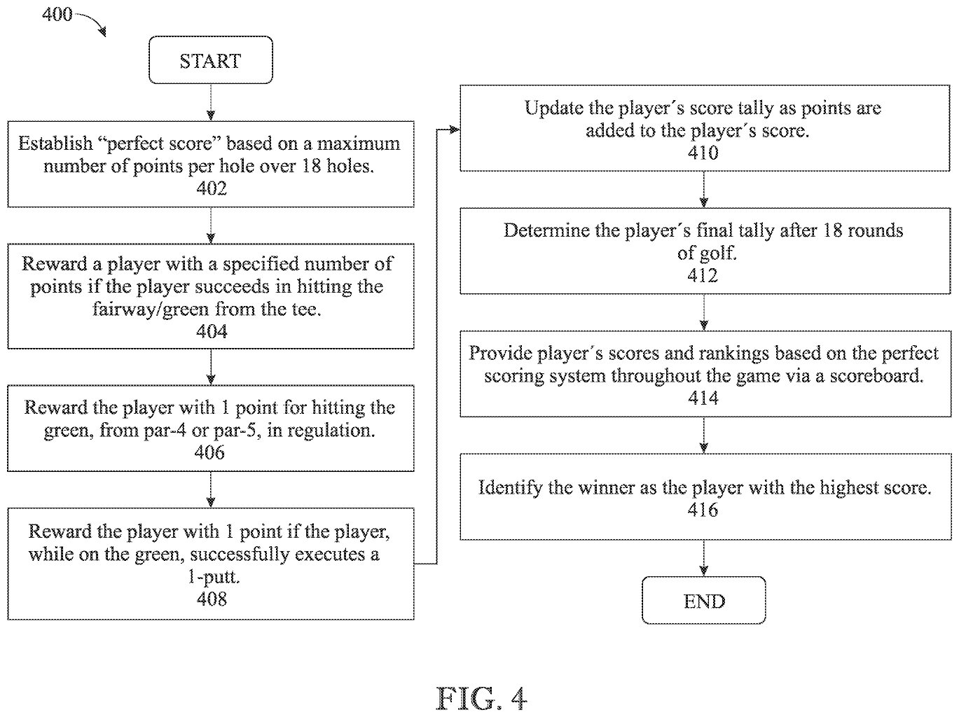

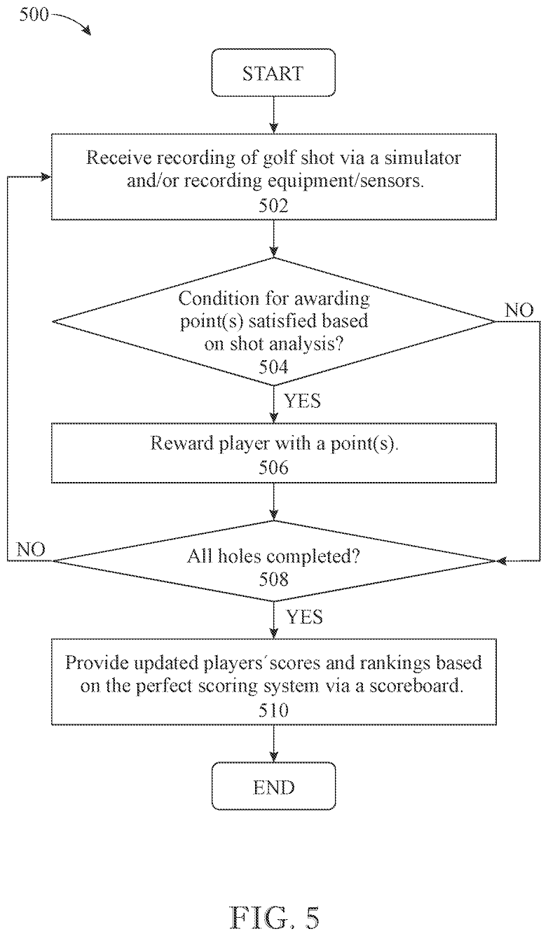

FIGS. 4 and 5 are flow charts illustrating various methods by which the above process of the illustrative embodiments is completed. Although the methods illustrated in FIGS. 4 and 5 may be described with reference to components shown in FIGS. 1-3, it should be understood that this is merely for convenience and alternative components and/or configurations thereof can be employed when implementing the various methods. Key portions of the methods may be completed by the Fulton Standard Scoring (FSS) module 108 executing on processor subsystem 102 within DPS 100 (FIG. 1) and controlling specific operations of/on DPS 100, and the methods are thus described from the perspective of either/both the FSS module 108 and DPS 100 or other device that provides the functionality associated with one or more versions of the FSS module 108.

FIG. 4 is a flow chart illustrating the process of scoring a golf game using the perfect scoring system. The process of FIG. 4 begins at the initiator, start block and proceeds to block 402, at which the FSS module 108 establish a “perfect score” based on a maximum number of points per hole over a specified number of holes. According to an implementation, the FSS module 108 sets a maximum number of points per hole as three (3) points and the specified number of holes as eighteen (18) holes. However, in other implementations, the FSS utility 108 can select a different maximum number of points per hole for game played over a different number of holes. At block 404, the FSS module 108 rewards a player with one point when a golf ball struck by the player succeeds in hitting the fairway from the tee. The FSS module 108 rewards the player with a specified number of points when a golf ball struck by the player succeeds in hitting the green in regulation, as shown at block 406. Referring particularly to blocks 404 and 406, on a player's approach to a 4-par or 5-par hole, the FSS module 108 rewards a player with one point if the player succeeds in hitting the fairway from the tee. However, if the player is targeting a 3-par hole, the FSS module 108 rewards the player with two (2) points if the player's first shot from the tee lands on the green. At block 408, the FSS module 108 rewards the player with 1 point if the player, while on the green, successfully executes a 1-putt. At block 410, the FSS module 108 update the player's score tally as points are added to the player's score. At block 412, the FSS module 108 determines the player's final tally after 18 rounds of golf. At block 414, the FSS module 108 provide the players' scores and rankings based on the perfect scoring system throughout the game via a scoreboard. At block 416, the FSS module 108 identifies the player with the highest score as the winner of the game. The process proceeds to the end block.

FIG. 5 is a flow chart illustrating the process of using a recording of a golf shot to determine whether points should be awarded to a golfer. The process of FIG. 5 begins at the initiator/start block and proceeds to block 502, at which the FSS utility 108 receives via a simulator and/or recording equipment/sensors a recording of a golf shot produced by a player/golfer. At decision block 504, the FSS utility 108 determines whether a condition for awarding a specified number of points is satisfied based on shot analysis. According to one or more aspects, on a player's approach to a 4-par or 5-par hole, the FSS utility rewards a player with one point if the player succeeds in hitting the fairway from the tee. Additionally, a player receives 1 point for hitting the green in regulation. If the player is targeting a 3-par hole, the FSS module/utility 108 rewards the player with two (2) points if the player's first shot from the tee lands on the green. Another point is awarded to a player if the player, while on the green, successfully executes a 1-putt. If at decision block 504 the FSS module 108 determines that the condition for awarding the specified number of points is satisfied, the FSS module 108 rewards the player with the specified number of points, and the process moves to decision block 508. However, if at decision block 504 the FSS module 108 determines that the condition for awarding the specified number of points is not satisfied, the FSS module 108 determines whether all holes of golf play have been completed, as shown at decision block 508. If at decision block 508 the FSS module 108 determines that all holes of golf play are completed, the FSS module 108 provides updated players' scores and rankings based on the perfect scoring system via a scoreboard, as shown at block 510. However, if at decision block 508 the FSS module 108 determines that all holes of golf play are not completed, the process returns to block 502 FSS module 108 receives a golf shot record for another shot. The process concludes at the end block.

The method, the system and the computer program product provide scoring for a golf game based on individual shots. A Fulton Standard Scoring (FSS) utility scores a golf game based on an ideal/perfect/maximum score. The FSS utility establishes the “perfect score” as fifty-four (54) points based on a 3 point maximum number of points per hole over 18 holes. On a player's approach to a par-4 or par-5 hole, the FSS utility rewards a player with one point if the player succeeds in hitting the fairway from the tee. Additionally, a player receives 1 point for hitting the green in regulation. If the player is targeting a par-3 hole, the FSS utility rewards the player with two (2) points if the player's first shot from the tee lands on the green. Another point is awarded to a player if the player, while on the green, successfully executes a 1-putt. A player who successfully executes these plays for eighteen (18) holes) achieves the maximum score of 54 points. The FSS utility tracks each player's scoring performing round by round and provides updated scores and player rankings via a scoreboard.

According to one or more aspects, the FSS utility 108 determines based on the recorded and/or simulated golf shot whether the golfer should be awarded a point(s) for the current shot. According to an aspect, the FSS utility 108 utilizes shot analyzer 104 to determine whether the shot satisfies any criterion/condition that enables the golfer/individual to be awarded a point(s). The shot analyzer 104 is able to determine any of the following (i) whether the player succeeds in hitting the fairway from the tee; (ii) whether the player hits the green in regulation, and (iii) whether the player successfully executes a 1-putt, while on the green.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

1. A computerized method for tracking and scoring a golf game, the method comprising:
establishing a target score based on a maximum number of points per hole over a specified number of holes;
receiving a recording of a golf shot via a simulator and/or sensors;
rewarding a player with a specified number of points for an occurrence of one or more of the following conditions; (i) the player succeeds in hitting the fairway or green from the tee; (ii) the player succeeds in hitting the green in regulation; and (iii) the player successfully executes a 1-putt, while on the green;
updating a player's score tally as points are added to the player's score;
providing players' rankings based on the target score throughout the game, and
identifying a winner as the player with the highest score.
